(19) United States
(12) Patent Application Publication
(10) Pub. No.: US 2005/0108281 A1
(43) Pub. Date: May 19, 2005

(54) Expertise modelling

(76) Inventors: Sanghee Kim, Southampton Hampshire (GB); Wendy Hall, Southampton Hampshire (GB)

Correspondence Address: CROWELL & MORING LLP;INTELLECTUAL PROPERTY GROUP, P.O. BOX 14300, WASHINGTON, DC, 20044-4300, US

(21) Appl. No.: 10/506,504

(22) PCT Filed: Feb. 28, 2003
(86) PCT No.: PCT/GB03/00870

(30) Foreign Application Priority Data
Mar. 5, 2002 (GB) 0205097.9
Aug. 12, 2002 (GB) 0218589.0

(51) Int. Cl. G06F 17/00

(52) U.S. Cl. 707/104.1

(57) ABSTRACT

A method of ranking experts in a subject matter field in an expertise model by selecting documents from the set of documents that refer to the subject to create a subject related subset of documents, selecting extracts from the subset of documents that refer to the subject and then analysing the linguistic structure of the extracts.

This invention relates to methods of expertise modelling and more particularly to methods of ranking experts in a subject matter field.

In large and/or multi-site based organisations it is difficult to utilise the expertise of individuals to the best advantage of the organisation. Thus, for example, one part of an organisation may “reinvent the wheel” because they are not aware of work carried out some years previous or indeed concurrently by another part of an organisation. Another common example of where organisations do not make best use of individuals' knowledge is where another individual within the organisation needs help in a particular area in which they are not “expert” or in other words they are a novice. Often the best solution is to find someone else within the organisation with the relevant expertise, namely an expert who can answer the novice's questions. However, often novices have difficulty characterising their own questions and expertise and this hinders their search for an expert to assist them.

To assist organisations make better use of individuals' knowledge Expert Finder systems have been developed. An Expert Finder is a system designed to locate people who have “sought-after knowledge” to solve a specific problem. It provides the names of potential helpers against knowledge seeking queries, in order to establish personal contacts which link novices to experts. The ultimate goal of such a system is to create environments where users are aware of each other, maximising their current resources and actively exchanging up-to-date information. Although the expert finder systems cannot always generate correct answers, bringing the relevant people together provides opportunities for them to become aware of each other, and to have further discussions, which may uncover hidden expertise.

Not only do Expert Finders help to effectively manage the useful knowledge held by individuals and thus supplement additional resources, but it also contributes timely and up-to-date procedural and factual knowledge to enterprises. In order to fully maximise individually held resources, it is necessary to encourage people to share such valuable data. To enable such data to be utilised to its maximum potential it important that the collection and management of the data does not interfere with an individual's everyday tasks or place onerous obligations on individuals. Thus collection and management must be “invisible” to the individual until their assistance is required. As expertise is accumulated through task achievement, it is also important to exploit it as it is created. To achieve this an automated system that does not rely on the individual is required. Such an approach allows individuals to work as normal without demanding changes in working environments.

Expert Finders exploit already existing data banks such as e-mail communications to capture personal expertise while allowing users to work as they normally would do without changing the working environment. E-mail communications are an ideal data bank for Expert Finders to exploit because e-mail communication has become a major means of exchanging information and acquiring social or organisational relationships, thus it can be a good source of information about recent and useful co-operative activities among users. In addition, as it represents an everyday activity, it requires no major changes to working environment.

Other data banks, such as an electronic library of reports, minutes of meetings or transcripts of telephone conversations may be used.

User profiles are created to decide whether an individual is an expert for a given problem. The standard method of creating user profiles is based on a statistical approach. The frequency of keywords in documents and the number of documents a user has created containing the keywords, are used to rank users for different subjects, creating user profiles. User profiles may also contain rankings for other factors, such as “helpfulness”, that is how willing they are to assist other users when contacted by counting the number of responses to queries and the speed of responses.

KnowledgeMail™ from Tacit Knowledge Systems Inc. (www.tacit.com./knowledgemail) adds an automatic profiling ability to some of the existing commercial e-mail systems, to support information sharing through executing queries about the profiles constructed. User profiles are formulated as a list of weight-valued terms by using a statistical method. A survey focusing on the system's performance reveals that users tend to spend extra time cleaning up their profiles in order to reduce false hits, which erroneously recommend them as experts due to unresolved ambiguous terms.

Maybury, M., D'Amore, R., House, D. (2001) Automated Discovery and Mapping of Expertise, developed an Expert Finder system that exploits the intellectual products created within an organisation to support automated expertise identification. The system considered a user as an expert if he/she was linked to a wide range of documents and/or a large number of documents about that topic. It combines multiple evidence demonstrating associations with the user in determining the level of expertise of the user. This qualifies experts by requiring detailed evidence, however, such evidence is collected from the measurement of information usage patterns, rather than from the analysis of the meanings and functional roles of such information.

However such a statistical approach has severe drawbacks including;
counting keywords is not adequate for determining whether a given document is factual information or contains some level of author expertise.
without understanding the semantic meanings of keywords, it is possible to assume that different words represent the same concept and vice versa, which triggers the retrieval of non-relevant information.
it is not easy to distinguish question-type texts from potential answer documents, meaning asking a question about a subject will improve a user's profile even though it may mean the user has little knowledge on a subject which is why they are asking the question.

It is an object of the present invention to provide a different method of creating user profiles and expert rankings, providing more meaningful user profiles.

A first aspect of the present invention provides a method for ranking creators of a set of documents in order of their expertise in a subject including the steps of:
selecting documents from the set of documents that refer to the subject to create a subject related subset of documents;
selecting extracts from the subset of documents that refer to the subject;
analysing the linguistic structure of the extracts;
using the analysis to rank the creators.

The step of analysing the linguistic structure of the extracts may include:
isolating verbs in the extracts to create a set of verbs for classification and,
classifying each isolated verb in the set of verbs according to a predetermined hierarchy.

User expertise may be considered to be action-centred and often distributed in the individual's action-experiences and thus using linguistic modelling action-centred statements in the extracts can be highlighted and thus a more sophisticated analysis of sentences or extracts containing references to a subject in a document can be made, allowing expert rankings to be derived. With this approach, the extracts may be regarded as the realisation of involved knowledge, user expertise can be verbalised as a direct indication of user views on discussed subjects, and the levels of expertise are distinguished by taking into account the degree of significance of the words employed in the extracts.

The predetermined hierarchy may be created by:
mapping isolated verbs to an illocutionary verb in a predefined set of illocutionary verbs and;
classifying the mapped isolated verbs according to the Speech Act Theory category of the corresponding illocutionary verb.

Speech Act Theory (SAT) proposes that communication involves the speaker's expression of an attitude (i.e. an illocutionary act) towards the contents of the communication. It suggests that information can be delivered with different communication effects on recipients depending on different speaker's attitudes, which are expressed using an appropriate illocutionary act, which represents a particular function of communication. The performance of the speech act is described by a verb, which posits a core element as the central organiser of a sentence.

More verbs may be classified by:
filtering isolated verbs not having a predefined illocutionary verb and thus not successfully mapped to the set of illocutionary verbs and;
checking for synonyms of the unmapped isolated verbs, that have a predefined illocutionary verb, and
classifying the each isolated verb not having a predefined illocutionary verb in the same category as its synonym.

In order to increase the number of verbs covered by the predetermined hierarchy a practical solution is to check for synonyms that have illocutionary verbs in the predetermined hierarchy and classify the original verb in the same way as the synonym with a illocutionary verb defined.

Isolated verbs that are not classified may not be used for ranking purposes and thus may be discarded.

Syntactical analysis can be used to isolate verbs by identifying the syntactic roles of words in a sentence using a corpus annotation Apple Pie Parser, which is a bottom-up probabilistic chart parser that finds the parse tree with the best score by the best-first search algorithm. The sentence is decomposed into a group of grammatically related phrases, such as “noun”, “adverb”, “adjective”, “verb”, or “preposition”.

Weighting extracts to favour those written in the first person receive over those written in the third person may also be used to further refine the ranking process.

SAT says that the fact that working practices are reflected through task achievement. Thus it can be considered that personal expertise can be regarded as action-oriented, emphasising the important role of a “first person” subject in expertise modelling.

Of course the extracts selected maybe single sentences.

According to a second aspect of the present invention there is provided a computer programme executable to rank creators of a set of documents in order of their expertise in a subject utilising the method as previously described.

According to a third aspect of the present invention there is provided a computer programmed to rank creators of a set of documents in order of their expertise in a subject according to the method as previously described.

According to a fourth aspect of the present invention there is provided a computer to rank creators of a set of documents in order of their expertise including means for:
selecting documents from the set of documents that refer to the subject to create a subject related subset of documents;
selecting extracts from the subset of documents that refer to the subject;
analysing the linguistic structure of the extracts; and
using the analysis to rank the creators.

According to a fifth aspect of the present invention there is provided a system operable to rank creators of a set of documents in order of their expertise in a subject comprising the method as previously described.

By way of example only an embodiment of the invention will now be described with reference to the accompanying figures in which:

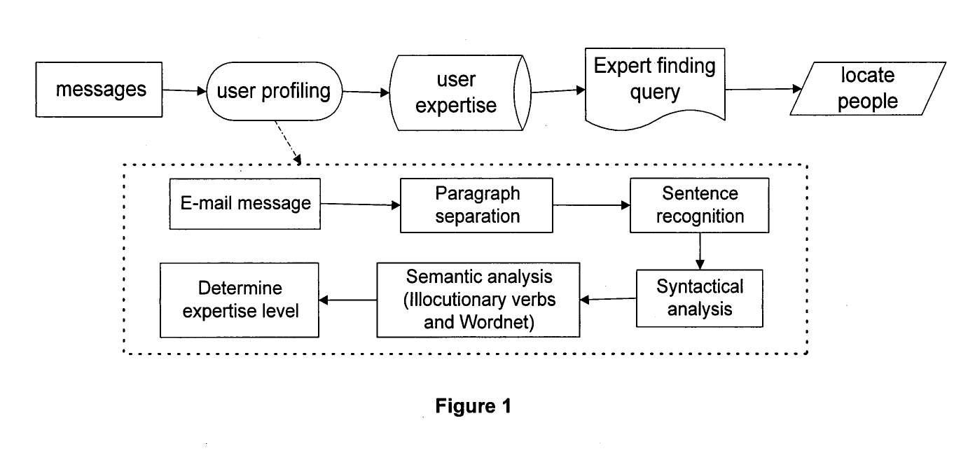

FIG. 1 is a flow diagram outlining the procedure for using Natural Language Processing-based user profiling;

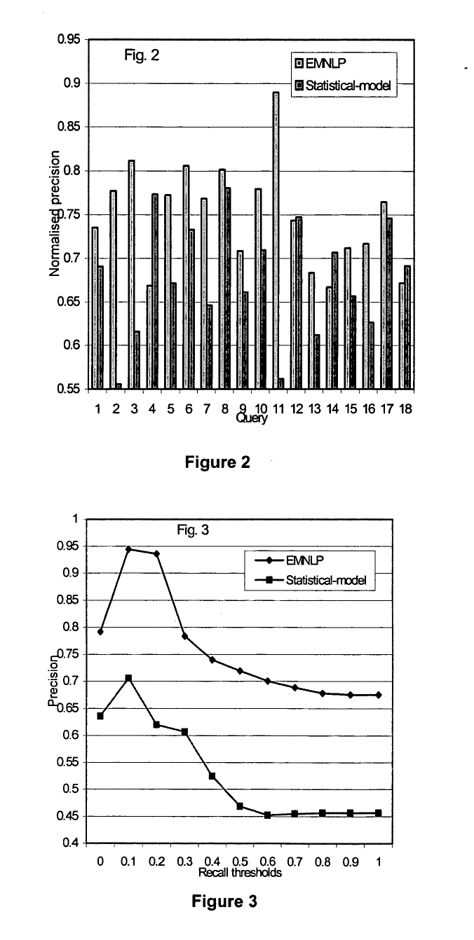

FIG. 2 is a graph summarising the results a case study carried out to test that Expertise Modelling using Natural Language Processing produces comparable or higher accuracy in differentiating expertise from factual information compared to that of the frequency-based statistical model, and that differentiating expertise from factual information supports more effective query processing in locating the right experts; and

FIG. 3 is a graphical representation of the precision-recall of the same case study as represented in FIG. 2.

An expertise model, EMNLP (Expertise Modelling using Natural Language Processing) captures the different levels of expertise reflected in exchanged e-mail messages, and makes use of such expertise in facilitating a correct ranking of experts. A design objective of EMNLP is to improve the efficiency of the task search, which ranks peoples' names in decreasing order of expertise against a help-seeking query. Its contribution is to turn once simply archived e-mail messages into knowledge repositories by approaching them from a linguistic perspective, which regards the exchanged messages as the realization of verbal communication among users. Its supporting assumption is that user expertise is best extracted by focusing on the sentence where users' viewpoints are explicitly expressed. NLP is identified as an enabling technology that analyses e-mail messages with two aims; 1) to classify sentences into syntactical structures (syntactic analysis), and 2) to extract users' expertise levels using the functional roles of given sentences (semantic interpretation). FIG. 1 shows the procedure for using EMNLP, i.e. how to create user profiles from the collected messages. Further details of the NLP components are explained within the dotted line. Contents are decomposed into a set of paragraphs and heuristics (e.g., locating a full stop) are applied in order to break down each paragraph into sentences.

Syntactical analysis identifies the syntactic roles of words in a sentence by using a corpus annotation Apple Pie Parser, which is a bottom-up probabilistic chart parser and finds the parse tree with the best score by the best-first search algorithm. The syntactical analysis supports the location of a main verb in a sentence, by decomposing the sentence into a group of grammatically related phrases, such as “noun”, “adverb”, “adjective”, “verb”, or “preposition”.

Given the structural information about each sentence, semantic analysis examines sentences with two criteria:
1) whether the employed verb verbalizes the speaker's attitudes, and
2) whether the sentence has a “first person” (e.g., “I”, “In my opinion”, or “We”) subject.

This analysis is based on Speech Act Theory (SAT), which proposes that communication involves the speaker's expression of an attitude (i.e. an illocutionary act) towards the contents of the communication. It suggests that information can be delivered with different communication effects on recipients depending on different speaker's attitudes, which are expressed using an appropriate illocutionary act, which represents a particular function of communication. The performance of the speech act is described by a verb, which posits a core element as the central organiser of the sentence. In addition, the fact that working practices are reflected through task achievement implies that personal expertise can be regarded as action-oriented, emphasizing the important role of a “first person” subject in expertise modelling.

EMNLP extracts user expertise from the sentences, which have “first person” subjects, and determines expertise levels based on the identified main verbs. Whereas SAT reasons about how different illocutionary verbs convey the various intentions of speakers, NLP determines the intention by mapping the central verb in the sentence to the pre-defined illocutionary verb. The decision about the level of user expertise is made according to the defined hierarchies of the verbs, initially provided by SAT. SAT provides the categories of illocutionary verbs (i.e. assertive, commissive, directive, declarative, and expressive), each of which contains a set of exemplary verbs. EMNLP further extends the hierarchy in order to increase its coverage for practicability by using the WordNet Database. EMNLP first examines all verbs occurring in the collected messages, and then filters out verbs, which have not been mapped onto the hierarchy. For each verb, it consults the WordNet database in order to assign a value through chaining its synonyms; for example, if the synonym of the given verb is classified into “assertive” value, and then this verb is also assigned into “assertive”.

To clarify how two sentences, that may be assumed to contain similar keywords, are mapped onto different profiles, consider two example sentences:
1) “For the 5049 testing, phase analysis on those high frequency results that Rob plotted is needed”, and
2) “For the 5049 testing, I know we need phase analysis on those high frequency results that Rob plotted”.

The main verb values for both sentences (i.e., need and know) are equivalent to “Strong Working Knowledge”, which conveys a relatively high knowledge for a speaker. However, the difference is that when compared to the first, the second sentence clearly conveys the speaker's intention as it begins with “I know”. As a consequence, it is regarded as demonstrating expertise while the first sentence is not. Information extracted from the first sentence is mapped onto a lower-level expertise.

A case study was developed to test two hypotheses; namely
1) that EMNLP produces comparable or higher accuracy in differentiating expertise from factual information compared to that of the frequency-based statistical model, and
2) that differentiating expertise from factual information supports more effective query processing in locating the right experts.

As a baseline, a frequency-based statistical model, which builds user profiles by weighting presented terms without considering their meanings or purposes was used.

A total of 10 users, who work for the same department in a professional engineering design company, participated in the experiment and a period of three-to-four months duration was spent collecting e-mail messages. A total of 18 queries was created for a testing dataset, and a maximum number of 40 names of predicted experts, i.e. 20 names extracted using EMNLP and 20 names from the statistical model, were shown to a user, who was the group leader of the other users. As a manager, the user was able to evaluate the retrieved names according to the five pre-defined expertise levels: “Expert-Level Knowledge”, “Strong Working Knowledge”, “Working Knowledge”, “Strong Working Interests” and “Working Interests”.

FIG. 2 summarizes the results measured by normalised precision. For 4 questions, EMNLP produced lower performance rates than by using the statistical approach. However, for 14 queries, its ranking results were more accurate, and at the highest point, it outperformed the statistical method with a 33% higher precision value. The precision-recall curve, which demonstrates a 23% higher precision value for EMNLP, is shown in FIG. 3. The differences of precision values at different recall thresholds are rather small with EMNLP, implying that its precision values are relatively higher than those of the statistical model.

A close examination of the queries used for testing reveals that the statistical model has a better capability in processing general-type queries that search for non-specific factual information, since
1) as we regard user expertise as action-oriented, knowledge is distinguished from such factual information, implying that it is difficult to value factual information as knowledge with EMNLP, and
2) EMNLP is limited to exploring various ways of determining the level of expertise in that it constrains user expertise to be expressed through the first person in a sentence.

EMNLP was developed to improve the accuracy of ranking the order of expert names by use of the NLP technique to capture explicitly stated user expertise, which otherwise may be ignored. Its improved ranking order, compared to that of a statistical method, was mainly due to the use of an enriched expertise acquisition technique, which successfully distinguished experienced users from novices. It is envisaged that EMNLP would be particularly useful when applied to large organisations where it is vital to improve retrieval performance since typical queries may be answered with a list of a few hundred potential expert names.

Special attention is given to gathering domain specific terminologies possibly collected from technical documents such as task manuals or memos. This is particularly useful for the semantic analysis, which identifies concepts and relationships within the NLP framework, since these terminologies are not retrievable from general-purpose dictionaries (e.g. the WordNet database).

It will be understood by the skilled reader that e-mail communication is just one of a number examples of databases of information that could be used with an expert model system as described above. For example in a Java Programming domain, the system could model a user's programming skill by reading source code files, and analysing what classes, libraries or methods are used and how often. This result is then compared to the overall usage for the remaining users, to determine the levels of expertise for specific topics (e.g., methods). Its automatic profiling and mapping of five levels of expertise (i.e., expert-advanced-intermediate-beginner-novice) in accordance with the prior art. However the system could be refined by assessing various coding patterns that might reveal the different skills of experts and beginners in a similar way to the analysis of the linguistic structure described above.

1. A method for ranking creators of a set of documents in order of their expertise in a subject including the steps of:
selecting documents from the set of documents that refer to the subject to create a subject related subset of documents;
selecting extracts from the subset of documents that refer to the subject;
analyzing the linguistic structure of the extracts by isolating verbs in the extracts to create a set of verbs for classification;
classifying each isolated verb in the set of verbs according to a predetermined hierarchy; and
using the analysis to rank the creators.

2. A method for ranking creators of a set of documents according to claim 1 including the further step of:
creating the predetermined hierarchy by mapping isolated verbs to an illocutionary verb in a predefined set of illocutionary verbs and;
classifying the mapped isolated verbs according to the Speech Act Theory category of the corresponding illocutionary verb.

3. A method for ranking creators of a set of documents according to claim 2 including the further step of:
filtering isolated verbs not having a predefined illocutionary verb and thus not successfully mapped to the set of illocutionary verbs and;
checking for synonyms of the unmapped isolated verbs, that have a predefined illocutionary verb and;
classifying the unmapped isolated verbs according to the Speech Act Theory of the corresponding illocutionary verb of it synonym.

5. A method for ranking creators according to claim 1, wherein isolating verbs includes the step of:
decomposing sentences in the extracts into a group of grammatically-related phrases, such as “noun”, “adverb”, “adjective”, “verb” or “preposition”.

5. A method for ranking creators of a set of documents according to claim 1, including the step of:
weighting extracts to favor those written in the first person over those written in the third person.

6. A method for ranking creators according to claim 1, wherein the set of documents is e-mail communications.

7. A computer program executable to rank creators of a set of documents in order of their expertise in a subject according to the method of claim 1.

8. A computer programmed to rank creators of a set of documents in order of their expertise in a subject according to the method of claim 1.

9. A computer to rank creators of a set of documents in order of their expertise including means for:
selecting documents from the set of documents that refer to the subject to create a subject related subset of documents;
selecting extracts from the subset of documents that refer to the subject;
analyzing the linguistic structure of the extracts by isolating verbs in the extracts to create a set of verbs for classification, and classifying each isolated verb in the set of verbs according to a predetermined hierarchy and using the analysis to rank the creators.
